(19) United States
(12) Patent Application Publication
(10) Pub. No.: US 2004/0098878 A1
(43) Pub. Date: May 27, 2004

(54) Clothes dryer and cooling passage structure for cooling condenser thereof

(76) Inventors: Young Hwan Park, Kwangmyong-shi (KR); Choon Myun Chung, Kwangmyong-shi (KR); Mu Yong Choi, Seoul (KR); Dae Yun Park, Kwangmyong-shi (KR); Kyung Seop Hong, Inchon-kwangyokshi (KR)

Correspondence Address: BIRCH STEWART KOLASCH & BIRCH, PO BOX 747, FALLS CHURCH, VA, 22040-0747, US

(21) Appl. No.: 10/410,287

(22) Filed: Apr. 10, 2003

(30) Foreign Application Priority Data
Nov. 27, 2002 (KR) P2002-74390

(51) Int. Cl. F26B 11/02; F26B 19/00

(52) U.S. Cl. 34/595; 34/62

(57) ABSTRACT

A clothes dryer and a cooling passage structure for cooling a condenser thereof is disclosed, which includes front and rear inhalation holes provided at a cabinet of the clothes dryer; and a guide duct provided to connect a condenser to a cooling fan, for forming a flow passage of an external air flown through the front and rear inhalation holes. At this time, the guide duct is provided such that an outlet side of the condenser exhausting the external air is connected to an inlet side of the cooling, fan inhaling the external air after passing through the condenser. The outlet side of the condenser exhausting the external air after passing through the condenser is opposite to the inlet side of the cooling fan inhaling the external air. Also, if the cooling fan is composed of a sirocco fan, which is provided such that the external air passing through the cooling fan is discharged to the rear side of the cabinet. If the cooling fan is composed of a cross-flow fan, which is provided such that the external air passing through the cooling fan is discharged to the lateral side of the cabinet.

This application claims the benefit of the Korean Application No. P2002-74390 filed on Nov. 27, 2002, which is hereby incorporated by reference.

### BACKGROUND OF THE INVENTION

1. Field of the Invention

The present invention relates to clothes dryer, which dries wet clothes (laundry) with a hot air in a drum thereof.

2. Discussion of the Related Art

In general, clothes dryer is an apparatus for drying clothes by removing moist from wet clothes (laundry) with a blow of a hot air generated by a heater. The clothes dryer is largely classified into an exhausting-type clothes dryer and a condensing-type clothes dryer according to a method for processing humid air generated during drying the wet clothes. In the exhausting-type clothes dryer, the humid air generated during drying the wet clothes in a drum is exhausted to the outside of the clothes dryer. Meanwhile, in the condensing-type clothes dryer, moist of the humid air is condensed, and then is removed from the humid air. After that, a dry air removing the moist is flown into the inside of the drum, thereby re-circulating the dry air in the drum.

The related art condensing-type clothes dryer will be described with reference to the accompanying drawings.

FIG. 1 is a plan view illustrating the related art condensing-type clothes dryer. In FIG. 1, an arrow I indicates a flow of a circulation air, and an arrow II indicates a flow of an external air.

Referring to FIG. 1, the related art condensing-type clothes dryer is provided with a cabinet 6, a drum 1, a circulation duct 6b, a filter 2, a circulation fan 3, a condenser 4, a cooling fan 8, a heater 5, and a motor 9. At this time, the cabinet 6 forms an external surface of the clothes dryer, and the cylindrical drum 1 for being rotatably provided in the cabinet 6 receives wet clothes (objects for drying) therein. For this, the drum 1 is connected to the motor 9 by a belt (not shown). The circulation duct 6b connects front and rear sides of the drum 1 with each other, for forming a passage of the circulation air of drying the wet clothes in the drum. The filter 2 filters out lint from the circulation air after drying the wet clothes. The circulation fan 3 forcibly circulates the circulation air through the circulation duct 6b by inhaling and blowing out the circulation air after passing through the filter 2. The condenser 4 connected to the middle portion of the circulation duct 6b removes moist from the humid circulation air by making a heat-exchange with a cool external air. For this, the cooling fan 8 is provided to be adjacent to the condenser 4 so as to inhale the external air passing through the condenser 4 in an axis direction, and to blow out the external air in a circumference direction toward the inside of the cabinet 6. In order to inflow the cool external air into the inside of the clothes dryer, one inhalation hole 6a is provided at the cabinet. Meanwhile, the heater 5 heats the dry circulation air from which the moist is removed in the condenser 4, and at least one heater 9 is provided for driving the drum 1, the circulation fan 3 and the cooling fan 8.

The operation of the related art drying-machine for clothes will be described as follows.

When a user puts the wet clothes in the drum 1, and operates the clothes dryer, the hot circulation air heated by the heater 5 is provided to the inside of the drum 1, thereby drying the wet clothes by removing the moist from the wet clothes. In this drying process step, the lint is removed from the circulation air during passing through the filter 2, and the filtered circulation air is blown into the condenser 4 by the circulation fan 3. The cool external air flown into the inside of the clothes dryer by the inhalation hole 6a passes through the condenser 4 by the cooling fan 8. At this time, the cool external air makes the heat-exchange with the high temperature and humid circulation air flowing in the inside of the condenser 4. After that, the external air completing the heat-exchange with the circulation air is discharged to the outside of the clothes dryer. The circulation air completing the heat exchange with the cool external air becomes dry. The dry circulation air is heated by the heater 5, and then is re-provided to the drum 1 for drying the wet clothes.

In the related art condensing-type clothes dryer, the cool external air for cooling the condenser 4 is flown to the inside of the clothes dryer through the one inhalation hole 6a provided at the cabinet of the clothes dryer, thereby increasing flow resistance of the circulation air. Also, when the external air passing through the condenser 4 is discharged, the external air is discharged from a discharging portion to an inlet side of the cooling fan 8 inhaling the external air at a right angle, thereby increasing the flow resistance of the external air discharged after passing through the condenser 4. Thus, it is hard to provide the external air enough for cooling the condenser 4, thereby decreasing the heat-exchange efficiency.

In the related art drying-machine for clothes, the external air is discharged to an internal front side of the clothes dryer through the cooling fan 8. However, there are many components in the internal front side of the clothes dryer, so that the external air discharged from the cooling fan 8 strikes on the components, thereby generating great circulation noise.

### SUMMARY OF THE INVENTION

Accordingly, the present invention is directed to a clothes dryer that substantially obviates one or more problems due to limitations and disadvantages of the related art.

An object of the present invention is to provide to a clothes dryer, in which a flow resistance of an external air introduced to the inside of the clothes dryer decreases.

Another object of the present invention is to provide a clothes dryer, which can improve condensing efficiency of a condenser by providing an external air enough for cooling the condenser, and drying efficiency of the clothes dryer.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a cooling passage structure for cooling a condenser of clothes dryer includes front and rear inhalation holes provided at the front and rear sides of a cabinet of the clothes dryer; and a guide duct provided to connect a condenser to a cooling fan, for forming a flow passage of an external air flown through the front and rear inhalation holes.

In another aspect, a clothes dryer includes a cabinet; front and rear inhalation holes provided at the front and rear sides of the cabinet; a cylindrical drum being rotatably provided in the cabinet; a circulation duct connecting front and rear sides of the drum for forming an air circulation passage; a condenser connected to the middle portion of the circulation duct; a heater for heating a circulation air circulating through the drum and the circulation duct; a circulation fan forcibly circulating the circulation air; a cooling fan inhaling the external air through the front and rear inhalation holes; at least one driving motor driving the drum, the circulation fan, and the cooling fan; and a guide duct connecting the condenser to the cooling fan flow passage of the external air.

The guide duct is provided such that an outlet side of the condenser exhausting the external air is connected to an inlet side of the cooling fan inhaling the external air after passing through the condenser.

The outlet side of the condenser exhausting the external air after passing through the condenser is opposite to the inlet side of the cooling fan inhaling the external air.

The cooling fan is composed of a sirocco fan, which is provided such that the external air passing through the cooling fan is discharged to the rear side of the cabinet.

The cooling fan is composed of a cross-flow fan, which is provided such that the external air passing through the cooling fan is discharged to the lateral side of the cabinet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principal of the invention. In the drawings:

FIG. 1 is a plan view illustrating a related art clothes dryer;

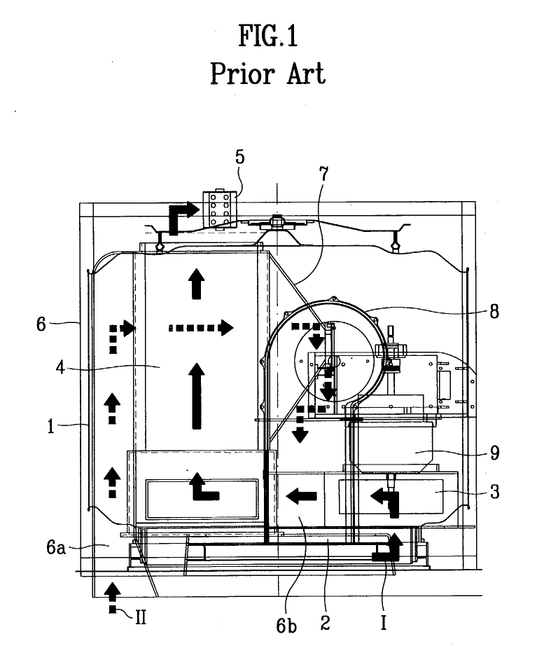

FIG. 2 is a plan view illustrating a clothes dryer according to the first embodiment of the present invention; and

FIG. 3 is a plan view illustrating a clothes dryer according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

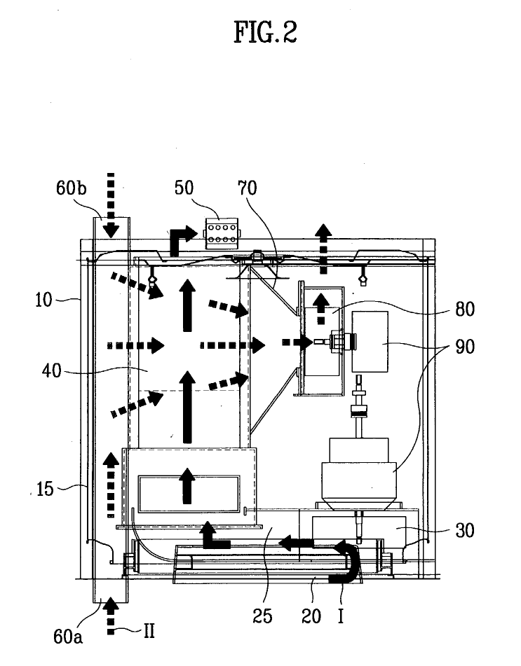

A clothes dryer according to the present invention will be described with reference to the accompanying drawings. FIG. 2 is a plan view illustrating a clothes dryer according to the first embodiment of the present invention. In FIG. 2, an arrow I indicates a passage of a circulation air, and an arrow II indicates a passage of an external air.

Referring to FIG. 2, the clothes dryer according to the present invention is provided with a cabinet 10, a drum 15, a circulation duct 25, a condenser 40, a cooling fan 80, a circulation fan 30, a heater 50, a filter 20, at least two inhalation-holes 60a and 60b, and a motor 90.

The cabinet 10 forms an external surface of the clothes dryer, and at least two inhalation-holes 60a and 60b are provided at the cabinet 10. For example, as shown in FIG. 2, front and rear inhalation holes 60a and 60b are respectively provided at front and rear sides of the cabinet 10.

The cylindrical drum 15 having a plurality of tumbling ribs (not shown) therein is rotatably provided inside the cabinet 10. At this time, the tumbling ribs are provided for lifting and dropping the wet clothes (objects for drying) received in the drum 15 during a rotation of the drum 15. The drum 15 is connected to the motor 90 by a belt.

The circulation duct 25 connects front and rear sides of the drum 15, for forming a flow passage of a circulation air of drying the wet clothes. Thus, the circulation air after drying the wet clothes in the drum 15 is circulated through the circulation duct 25, and then is re-flown into the inside of the drum 15.

The condenser 40 is provided at the middle portion of the circulation duct 25, so that the circulation air flowing in the circulation duct 25 passes through the condenser 40. Thus, the moist is removed from the high temperature and humid air generated during drying the wet clothes in the drum 15 by condensing the moist.

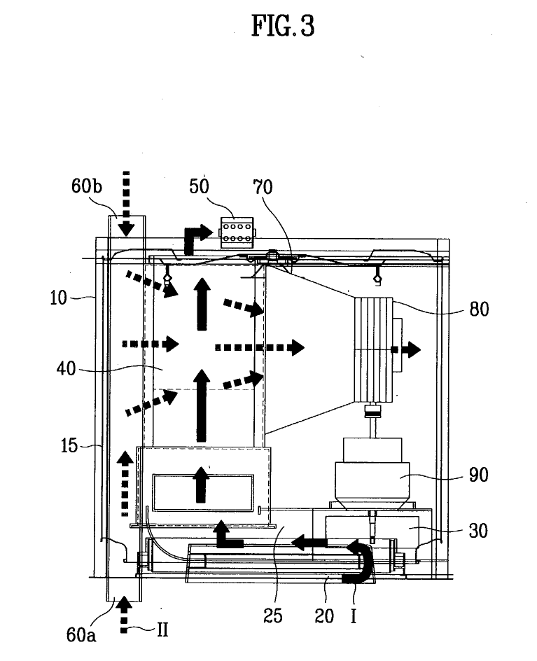

The cooling fan 80 is provided to be adjacent to the condenser 40 for inhaling, and blowing the cool external air through the inhalation holes 60a and 60b provided at the cabinet 10. At this time, the external air flown into the cabinet 10 through the inhalation holes 60a and 60b sequentially passes through the condenser 40 and the cooling fan 80, and then is discharged to the outside of the cabinet 10. As shown in FIG. 2, if the cooling fan 80 is composed of a sirocco fan, the cooling fan 80 is provided such that the external air passing through the cooling fan 80 is discharged to the rear side of the cabinet 10. As shown in FIG. 3, if the cooling fan 80 is composed of a cross-flow fan, the cooling, fan 80 is provided such that the external air passing through the cooling fan 80 is discharged to the lateral side of the cabinet 10. Meanwhile, in the clothes dryer according to the present invention, an outlet side of the condenser 40 exhausting the external air, after passing, through the condenser 40, is opposite to an inlet side of the cooling fan 80 inhaling the external air.

A guide duct 70 is provided to connect the condenser 40 to the cooling fan 80, for forming the flow passage of the external air flown through the front and rear inhalation holes 60a and 60b. At this time, the guide duct 70 connects the outlet side of the condenser 40 exhausting the external air to the inlet side of the cooling fan 80 inhaling the external air after passing through the condenser 40.

The circulation fan 30 is provided in the circulation duct 25 for forcibly circulating the circulation air. The heater 50 heats the circulation air, and the filter 20 removes the lint from the circulation air. At least one motor 90 is provided for driving the drum 15, the circulation fan 30, and the cooling fan 80. As shown in FIG. 2, if the cooling fan 80 is composed of the sirocco fan, two motors are provided so as to drive the drum 15, the circulation fan 30, and the cooling fan 80. Meanwhile, as shown in FIG. 3, if the cooling fan 80 is composed of the cross-flow fan, one motor 90 is provided, thereby driving the drum 15, the circulation fan 30, and the cooling fan 80.

In the operation of the clothes dryer according to the present invention, since process steps for drying, the wet clothes in the drum 15, removing the moist from the humid air in the condenser 40, and heating the dry air from which the moist is removed are same as those of the related art clothes dryer, an explanation for the process steps will be omitted. Thus, the operation of the clothes dryer according to the present invention will be described with an emphasis on the flow passage of the external air for cooling the condenser 40.

If the cooling fan 80 is rotated on driving of the clothes dryer, the cool external air is flown into the inside of the cabinet 10 through the front and rear inhalation holes 60a and 60b provided at the cabinet 10 in a great amount, as shown in FIG. 2 and FIG. 3. The external air flown into the inside of the cabinet 10 passes through the condenser 40, and makes the heat-exchange with the circulation air flowing in the inside of the condenser 40. Then, the circulation air completing the heat-exchange on flowing inside the condenser 40 is flown into the cooling, fan 80 by the guide duct 70, and then is discharged to the outside of the cabinet 10. At this time, as shown in FIG. 2, if the cooling, fan 80 is composed of the sirocco fan, the external air is discharged to the rear side of the cabinet 10. Meanwhile, if the cooling fan 80 is composed of the cross-flow fan, as shown in FIG. 3, the external air is discharged to the lateral side of the cabinet 10.

In the clothes dryer according to the present invention, the external air for cooling the condenser 40 is flown into the inside of the cabinet 10 through the front and rear inhalation holes 60a and 60b, thereby decreasing the flow resistance of the external air flown into the cabinet 10. Accordingly, a static pressure of the cooling fan 80 decreases, so that greater amount of the external air is provided to the condenser 40.

Also, the outlet side of the condenser 40 exhausting the external air is provided to be opposite to the inlet side of the cooling fan 80 inhaling the external air, thereby decreasing the flow resistance of the external air.

Accordingly, the humid circulation air flowing inside the condenser 40 makes the enough heat-exchange with the cool external air, so that it is possible to improve not only heat-exchange efficiency of the condenser but also drying efficiency of the clothes dryer.

After completing the heat-exchange in the condenser 40, the external air is discharged to the rear side or the lateral side of the cabinet 10 where the components are scarcely disposed, so that it is possible to minimize the external air discharged from the cooling fan 8 striking on the components, thereby decreasing the circulation noise of the external air discharged to the outside of the cabinet 10.

The condensing-type clothes dryer according to the present invention has the following advantages.

First, the clothes dryer according to the present invention has the two inhalation holes, so that it is possible to inhale the greater external air through the two inhalation holes, thereby improving the heat-exchange efficiency of the condenser, and the drying efficiency of the clothes dryer.

Also, the circulation noise of the external air discharged from the cooling fan decreases.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A cooling passage structure for cooling a condenser of a clothes dryer comprising:
front and rear inhalation holes provided at the front and rear sides of a cabinet of the clothes dryer; and
a guide duct provided to connect the condenser to a cooling fan, for forming a flow passage of an external air of the cabinet flown through the front and rear inhalation holes.

2. The cooling passage structure as claimed in claim 1, wherein the guide duct is provided such that an outlet side of the condenser exhausting the external air is connected to an inlet side of the cooling fan inhaling the external air after passing through the condenser.

3. The cooling passage structure as claimed in claim 1, wherein the outlet side of the condenser exhausting the external air after passing through the condenser is opposite to the inlet side of the cooling, fan inhaling the external air.

4. The cooling, passage structure as claimed in claim 2, wherein the outlet side of the condenser exhausting the external air after passing through the condenser is opposite to the inlet side of the cooling fan inhaling the external air.

5. The cooling passage structure as claimed in claim 3, wherein, the cooling fan is composed of a sirocco fan, which is provided such that the external air passing through the cooling fan is discharged to the rear side of the cabinet.

6. The cooling passage as claimed in claim 4, wherein the cooling fan is composed of a sirocco fan, which is provided such that the external air passing through the cooling fan is discharged to the rear of the cabinet.

7. The cooling passage as claimed in claim 3, wherein the cooling fan is composed of a cross-flow fan, which is provided such that the external air passing through the cooling fan is discharged to the lateral side of the cabinet.

8. The cooling passage as claimed in claim 4, wherein the cooling fan is composed of a cross-flow fan, which is provided such that the external air passing through the cooling fan is discharged to the lateral side of the cabinet.

9. A clothes dryer comprising:
a cabinet;
front and rear inhalation holes provided at the front and rear sides of the cabinet;
a cylindrical drum being rotatably provided in the cabinet;
a circulation duct connecting front and rear sides of the drum for forming an air circulation passage;
a condenser connected to the middle portion of the circulation duct;
a heater for heating a circulation air circulating through the drum and the circulation duct;
a circulation fan forcibly circulating the circulation air;
a cooling fan inhaling the external air through the front and rear inhalation holes;
at least one driving motor driving the drum, the circulation fan, and the cooling fan; and
a guide duct connecting the condenser to the cooling fan for forming a flow passage of the external air.

10. The clothes dryer as claimed in claim 9, wherein an outlet side of the condenser exhausting the external air is connected to an inlet side of the cooling fan inhaling the external air after passing through the condenser.

11. The clothes dryer as claimed in claim 9, wherein an outlet side of the condenser exhausting the external air after passing the condenser is opposite to an inlet side of the cooling fan inhaling the external air.

12. The clothes dryer as claimed in claim 10, wherein an outlet side of the condenser exhausting the external air after passing through the condenser is opposite to an inlet side of the cooling fan inhaling the external air.

13. The clothes dryer as claimed in claim 11, wherein the cooling fan is composed of a sirocco fan, which is provided such that the external air passing through the cooling fan is discharged to the rear side of the cabinet.

14. The clothes dryer as claimed in claim 12, wherein the cooling fan is composed of a sirocco fan, which is provided such that the external air passing through the cooling fan is discharged to the rear side of the cabinet.

15. The clothes dryer as claimed in claim 11, wherein the cooling fan is composed of a cross flow fan, which is provided such that the external air passing through the cooling fan is discharged to the lateral side of the cabinet.

16. The clothes dryer as claimed in claim 12, wherein the cooling fan is composed of a cross flow fan, which is provided such that the external air passing through the cooling fan is discharged to the lateral side of the cabinet.
